(19) United States
(12) Patent Application Publication
(10) Pub. No.: US 2015/0365395 A1
(43) Pub. Date: Dec. 17, 2015

(54) SOCIAL CONTENT INTEGRATION

(71) Applicant: WHATAGOOBER, LLC, The Woodlands, TX (US)

(72) Inventor: Ashley R. ENRIQUEZ, The Woodlands, TX (US)

(21) Appl. No.: 14/448,443

(22) Filed: Jul. 31, 2014

Related U.S. Application Data
(60) Provisional application No. 62/013,070, filed on Jun. 17, 2014.

(51) Int. Cl. H04L 29/06; H04L 12/58; H04L 12/24

(52) U.S. Cl. CPC H04L 63/083; H04L 41/28; H04L 65/403; H04L 51/32

(57) ABSTRACT

Herein disclosed is an integrated platform comprising at least one social network and one password to access the platform and the at least one social network. In some embodiments, the at least one social network comprises the integrated platform itself as a social network, Google+, Instagram, LinkedIn, Facebook, Twitter, Tumblr, or combinations thereof. In some embodiments, the integrated platform provides full function of the at least one social network. In some embodiments, the full function comprises logging in, registering, saving log-ins, following, posting, chatting, inviting friends, adding friends, sending messages, sending or uploading photos or videos, notifying, sharing, aggregating news feed. In some embodiments, the integrated platform provides a chatting function with a user-dictated timed self-destruct feature or instant self-destruct feature by shaking a mobile device on which the platform is installed. In some embodiments, the chatting function comprises photo or video correspondence.

### CROSS-REFERENCE TO RELATED APPLICATIONS

This application claims the benefit under 35 U.S.C. §119(e) of U.S. Provisional Patent Application No. 62/013,070, filed Jun. 17, 2014, the disclosure of which is hereby incorporated herein by reference.

### STATEMENT REGARDING FEDERALLY SPONSORED RESEARCH OR DEVELOPMENT

Not Applicable.

### BACKGROUND

1. Field of the Invention

The invention generally relates to systems and methods for social content monitoring and management. More particularly, the invention describes integration and management of social networks or social media.

2. Background of the Invention

Social media websites or social networks provide platforms for interactions between individuals/users. Current social media are many, such as Google+, Facebook, Twitter, YouTube, LinkedIn, Instagram, and Tumblr. Current social media platforms are fragmented, with each social media platform offering one or more features not offered by other social media platforms. The various social networks offer the possibility of multiple interactions between users, the fragmented nature of current social networks limits the value of any social interaction to a single social network or platform.

Accordingly, there is continuing need and interest to develop improved integration and management for social content monitoring. It is also desirable for each individual user to have the option and convenience of an integrated platform.

### SUMMARY

Herein disclosed is an integrated platform, executable by one or more computing systems, comprising at least one social network and one password to access said platform and the at least one social network.

In some embodiments, the at least one social network comprises the integrated platform itself as a social network, Google+, Instagram, LinkedIn, Facebook, Twitter, Tumblr, or combinations thereof. In some embodiments, the integrated platform provides full function of said at least one social network. In some embodiments, said full function comprises logging in, registering, saving log-ins, following, posting, chatting, inviting friends, adding friends, sending messages, sending or uploading photos or videos, notifying, sharing, aggregating news feeds.

In some embodiments, the integrated platform provides a chatting function with a user-dictated timed self-destruct feature or instant self-destruct feature by shaking a mobile device on which the platform is installed. In some embodiments, the self-destruct feature comprises erasing the chat on both the receiving side and the sending side. In some embodiments, the chatting function comprises photo or video correspondence.

In some embodiments, the at least one social network operates independent of other networks in the integrated platform.

In some embodiments, the integrated platform enables the user to pause or suspend any of the at least one social network; or act or respond in any of the at least one social network; or register as a new user or register using an existing social network account; or configure the signature of correspondence; or customize the background of the platform; or customize the fonts and colors and shapes of chat bubbles; or make free phone calls with the feature to record and/or to save the call; or customize a newsfeed on the bottom of screen; or pinch to re-size the view or auto-rotate from portrait to landscape view.

In some embodiments, the integrated platform provides a store for addition of features; or a memory box to save audios, photos, videos, chats, or combinations thereof; or advertisements between feeds. In some embodiments, the integrated platform comprises mobile application or web service or both.

Also discussed is an integrated platform, executable by one or more computing systems, comprising at least one social network and one password to access said platform and at least one social network; and a chatting function with a user-dictated timed self-destruct feature or instant self-destruct feature by shaking a mobile device on which the platform is installed, wherein the self-destruct feature comprises erasing the chat on both the sending side and the receiving side.

In some embodiments, the integrated platform provides full function of said at least one social network. In some embodiments, full function comprises logging in, registering, saving log-ins, following, posting, chatting, inviting friends, adding friends, sending messages, sending or uploading photos or videos, notifying, sharing, aggregating news feeds.

In some embodiments, said at least one social network comprises the integrated platform itself as a social network, Google+, Instagram, LinkedIn, Facebook, Twitter, Tumblr, or combinations thereof. In some embodiments, the integrated platform comprises mobile application or web service or both.

In some embodiments, the integrated platform enables the user to pause or suspend any of the at least one social network; or act or respond in any of the at least one social network; or register as a new user or register using an existing social network account; or configure the signature of correspondence; or customize the background of the platform; or customize the fonts and colors and shapes of chat bubbles; or make free phone calls with the feature to record and/or to save the calls; or customize a newsfeed on the bottom of screen; or pinch to re-size the view or auto-rotate from portrait to landscape view.

Further disclosed is an integrated platform, implementable by one or more computing systems, comprising at least one social network, wherein said at least one social network comprises the integrated platform itself as a social network, Google+, Instagram, LinkedIn, Facebook, Twitter, Tumblr, or combinations thereof; one password to access said platform and the at least one social network; and a chatting function with a user-dictated timed self-destruct feature or instant self-destruct feature by shaking a mobile device on which the platform is installed, wherein the self-destruct feature comprises erasing the chat on both the sending side and the receiving side.

In some embodiments, the integrated platform comprises mobile application or web service or both.

In some embodiments, the integrated platform enables the user to pause or suspend any of the at least one social network; or act or respond in any of the at least one social network; or register as a new user or register using an existing social network account; or configure the signature of correspondence; or customize the background of the platform; or customize the fonts and colors and shapes of chat bubbles; or make free phone calls with the feature to record and/or to save the calls; or customize a newsfeed on the bottom of screen; or pinch to re-size the view or auto-rotate from portrait to landscape view.

The invention comprises a combination of features and advantages which enable it to overcome various problems of prior devices. The various characteristics described above, as well as other features, will be readily apparent to those skilled in the art upon reading the following detailed description of the preferred embodiments of the invention, and by referring to the accompanying drawings.

It should be appreciated that all of the inventions, systems, and methods described and claimed herein can be implemented and/or executed on, made operable with, and/or implemented or carried out by any one or more user devices (including but not limited to smart phones, tablets, smart watches, wearables, and personal computers), one or more computers having computer-readable storage media, one or more non-transitory computer-readable media, one or more processors or processing machines, one or more processors or processor-based devices, and/or one or more servers. The foregoing, as well as the elements of the inventions, systems, and methods described and claimed herein, can interface, can be connected, and/or can communicate with one another via the internet, a wireless or wired network, or any other means of communication known to a person of ordinary skill in the art.

### BRIEF DESCRIPTION OF THE DRAWINGS

For a more detailed description of the preferred embodiment of the invention, reference will now be made to the accompanying drawings, wherein:

FIG. 1 illustrates an interface of an integrated platform, according to an embodiment of this disclosure.

FIG. 2 illustrates another interface of an integrated platform, according to an embodiment of this disclosure.

FIG. 3 illustrates the data flow of an integrated platform, according to an embodiment of this disclosure.

### DETAILED DESCRIPTION

Herein described is an integrated platform, implementable or executable by one or more computing systems, the platform comprising at least one social network and one password to access said platform and the at least one social network. The at least one social network comprises Google+, Instagram, LinkedIn, Facebook, Twitter, Tumblr, other social networks, or combinations thereof. The technical components are known in the art, such as in U.S. Pat. Nos. 8,631,473 and 8,635,674 and in U.S. Publication Nos. 20140006977, 20130014223, and 20130014222. The disclosures of these patents and publications are incorporated herein by reference in their entirety for all purposes.

As used herein, a computing system includes all types of systems, such as computers, computer farms/clusters, servers, mobile devices, smart phones.

The integrated platform of this disclosure enables/provides full function of the at least one social network. Such function includes logging in, registering, saving log-ins, following, posting, chatting, inviting friends, adding friends, sending messages, sending or uploading photos or videos, notifying, sharing, and aggregating news feeds.

Furthermore, the integrated platform provides a chatting function. And in some cases, such chatting function comprises a user-dictated timed self-destruct feature erasing the chat on both the sending side and the receiving side. For example, the user is able to set a time interval for the messages to self-destruct every 10 minutes or every 15 minutes. The time interval may be any number of minutes between, for example, 5-60 minutes. This chatting function also includes photo or video correspondence. The self-destruct feature/function on both the sending and receiving sides also applies to the photo/video correspondence. In addition, the platform provides the option of self-destructing the current chat on both the sending and receiving sides by shaking the mobile device, e.g., a smart phone.

The integrated platform provides the function of having advertisements between feeds. The platform has the ability to configure the signature of correspondence, e.g., “sent from . . . (e.g., WhataGoober)”. Users are also able to customize the background of the platform, e.g., by uploading/selecting/using photos. Users are able to customize the fonts and colors and shapes of chat bubbles within the platform; or pinch to re-size the view or auto-rotate from portrait to landscape view.

The integrated platform also provides a store within the platform for addition of features. The integrated platform provides a memory box option to save audios, photos, videos, chats, or combinations thereof. Users are able to make free phone calls through the integrated platform, e.g., via a Call Function. The integrated platform provides a call recording function for the Call Function. Furthermore, the platform is able to save the recorded phone calls in the Memory Box. Users are also able to customize a newsfeed on the bottom of screen.

In various embodiments, the integrated platform is a standalone social network with the functions/features as discussed herein. In various embodiments, the integrated platform is a social network that may be used in conjunction with existing or yet-to-be-developed social networks.

In the integrated platform, the various social networks operate independent of one another. The user is able to pause or suspend any of the social networks. The integrated platform also enables the user to act or respond in any of the social networks.

The integrated platform enables the user to register as a new user or register using an existing social network account. In some embodiments, once a user registers or logs in, the integrated platform is able to find the user's profiles in other social networks. In some embodiments, the integrated platform is able to upload a user's contacts from the other social networks into said integrated platform. In some embodiments, the integrated platform comprises mobile application or web service or both.

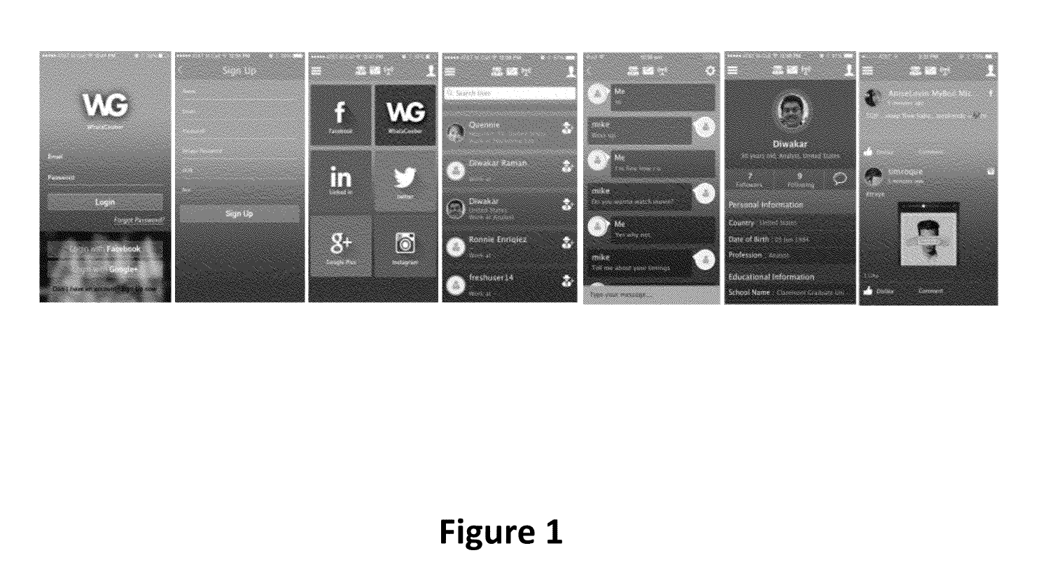

Referring to FIG. 1, an interface of the integrated platform is illustrated. From left to right, the first screen represents Login; the second screen represents a sign up page; the third screen represents the set up page; the fourth screen represents adding friends; the fifth screen represents Profile Page; the sixth screen represents the WhataGoober self-destruct chat page; the seventh screen represents the integrated feed page displaying news updates and various social network feeds.

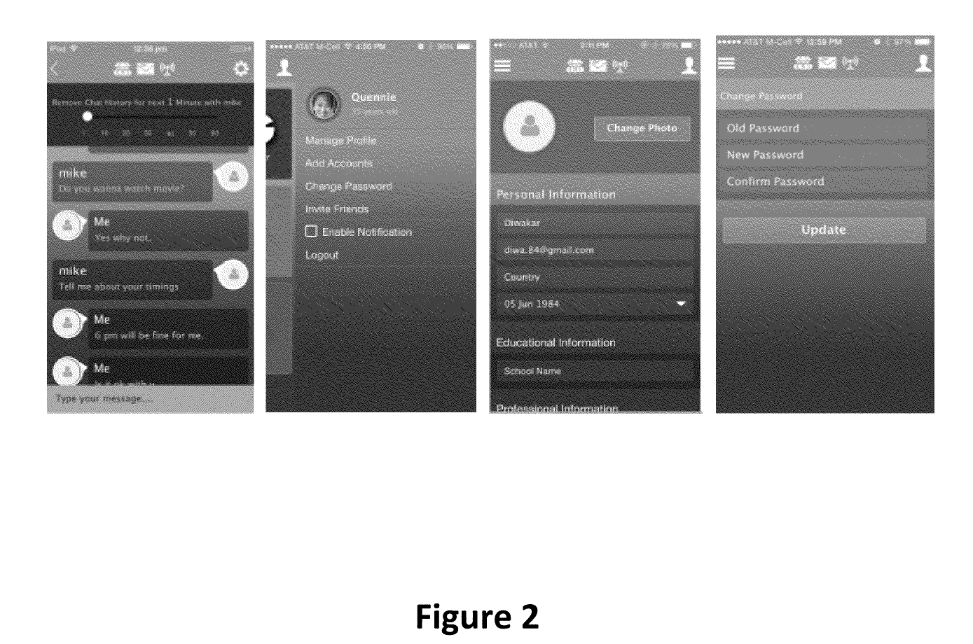

Referring to FIG. 2, another interface of the integrated platform is illustrated. From left to right, the first screen represents chat page with a timed self-destruct feature; the second screen represents the settings page; the third screen represents the profile page; and the fourth screen represents the change password page.

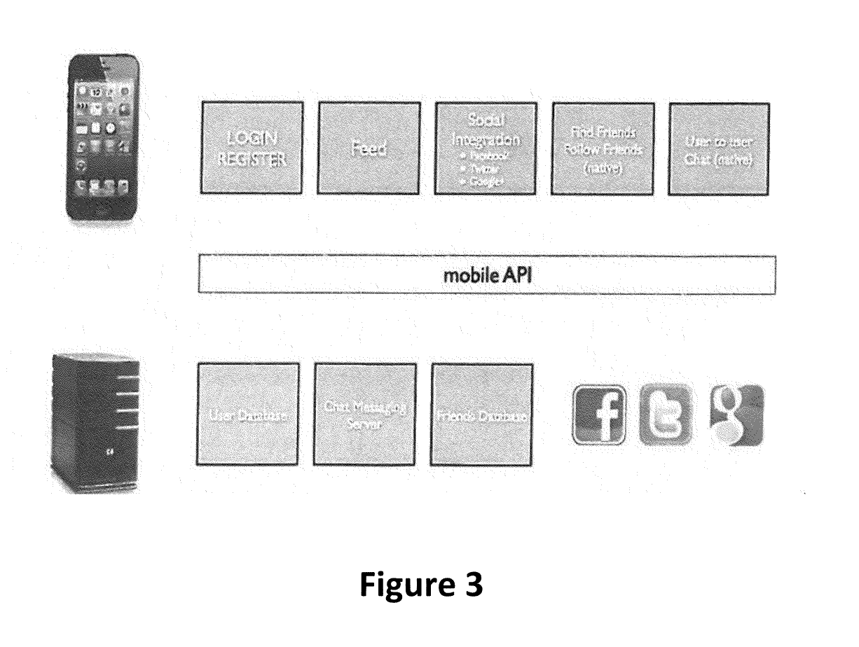

Referring to FIG. 3, the data flow of the integrated platform is illustrated. It is a general flow chart elaborating the basic elements of mobile API connectivity.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. An integrated platform, executable by one or more computing systems, comprising
at least one social network and one password to access said platform and the at least one social network.

2. The integrated platform of claim 1 wherein said at least one social network comprises the integrated platform itself as a social network, Google+, Instagram, LinkedIn, Facebook, Twitter, Tumblr, or combinations thereof.

3. The integrated platform of claim 1 providing full function of said at least one social network.

4. The integrated platform of claim 3 wherein said full function comprises logging in, registering, saving log-ins, following, posting, chatting, inviting friends, adding friends, sending messages, sending or uploading photos or videos, notifying, sharing, aggregating news feeds.

5. The integrated platform of claim 1 providing a chatting function with a user-dictated timed self-destruct feature or instant self-destruct feature by shaking a mobile device on which the platform is installed.

6. The integrated platform of claim 5 wherein the self-destruct feature comprises erasing the chat on both the receiving side and the sending side.

7. The integrated platform of claim 5 wherein the chatting function comprises photo or video correspondence.

8. The integrated platform of claim 1 wherein the at least one social network operates independent of other networks in the integrated platform.

9. The integrated platform of claim 1 enabling the user to
pause or suspend any of the at least one social network; or
act or respond in any of the at least one social network; or
register as a new user or register using an existing social network account; or
configure the signature of correspondence; or
customize the background of the platform; or
customize the fonts and colors and shapes of chat bubbles; or
make free phone calls with the feature to record and/or to save the call; or
customize a newsfeed on the bottom of screen; or
pinch to re-size the view or auto-rotate from portrait to landscape view.

10. The integrated platform of claim 1 providing
a store for addition of features; or
a memory box to save audios, photos, videos, chats, or combinations thereof; or
advertisements between feeds.

11. The integrated platform of claim 1 comprising mobile application or web service or both.

12. An integrated platform, executable by one or more computing systems, comprising
at least one social network and one password to access said platform and at least one social network; and
a chatting function with a user-dictated timed self-destruct feature or instant self-destruct feature by shaking a mobile device on which the platform is installed, wherein the self-destruct feature comprises erasing the chat on both the sending side and the receiving side.

13. The integrated platform of claim 12 providing full function of said at least one social network.

14. The integrated platform of claim 13 wherein said full function comprises logging in, registering, saving log-ins, following, posting, chatting, inviting friends, adding friends, sending messages, sending or uploading photos or videos, notifying, sharing, aggregating news feeds.

15. The integrated platform of claim 12 wherein said at least one social network comprises the integrated platform itself as a social network, Google+, Instagram, LinkedIn, Facebook, Twitter, Tumblr, or combinations thereof.

16. The integrated platform of claim 12 comprising mobile application or web service or both.

17. The integrated platform of claim 12 enabling the user to
pause or suspend any of the at least one social network; or
act or respond in any of the at least one social network; or
register as a new user or register using an existing social network account; or
configure the signature of correspondence; or
customize the background of the platform; or
customize the fonts and colors and shapes of chat bubbles; or
make free phone calls with the feature to record and/or to save the calls; or
customize a newsfeed on the bottom of screen; or
pinch to re-size the view or auto-rotate from portrait to landscape view.

18. An integrated platform, implementable by one or more computing systems, comprising
at least one social network, wherein said at least one social network comprises the integrated platform itself as a social network, Google+, Instagram, LinkedIn, Facebook, Twitter, Tumblr, or combinations thereof;
one password to access said platform and the at least one social network; and
a chatting function with a user-dictated timed self-destruct feature or instant self-destruct feature by shaking a mobile device on which the platform is installed, wherein the self-destruct feature comprises erasing the chat on both the sending side and the receiving side.

19. The integrated platform of claim 18 comprising mobile application or web service or both.

20. The integrated platform of claim 18 enabling the user to
pause or suspend any of the at least one social network; or
act or respond in any of the at least one social network; or
register as a new user or register using an existing social network account; or
configure the signature of correspondence; or
customize the background of the platform; or
customize the fonts and colors and shapes of chat bubbles; or
make free phone calls with the feature to record and/or to save the calls; or
customize a newsfeed on the bottom of screen; or
pinch to re-size the view or auto-rotate from portrait to landscape view.
